(19) United States
(12) Patent Application Publication
(10) Pub. No.: US 2012/0153648 A1
(43) Pub. Date: Jun. 21, 2012

(54) WASTE DISPOSAL SCOOP AND METHOD OF USE

(76) Inventor: MARGIE LACER, CYPRESS, CA (US)

(21) Appl. No.: 12/972,517

(22) Filed: Dec. 20, 2010

(51) Int. Cl. A01K 29/00

(52) U.S. Cl. 294/1.3

(57) ABSTRACT

A waste disposal scoop comprising a conical body, where the conical body extends between a base at a lower portion to an folded edge at an upper portion, a front flap attached to the folded edge, where the front flap folds to rest against the conical body, a back scoop attached to an opposing portion of the conical body from the folded edge, where the back scoop lifts an amount of animal waste to slide the animal waste into the conical body, and an adhesive strip attached to an end of the front flap, wherein the adhesive strip secures the front flap to the back scoop after the amount of animal waste is inside the conical body.

### BACKGROUND OF THE INVENTION

1. Field of the Invention

The present invention relates to a waste disposal scoop to enable a user to dispose of pet waste by providing a disposable container including an adhesive strip to scoop, seal and dispose of the waste.

2. Description of Related Art

All pet owners understand the responsibility and great importance of taking care of their pets. The responsibilities include cleaning, feeding, sheltering and exercising the animal. One of the least enjoyed parts of caring for an animal is cleaning up their waste. Most pet owners consider this the most disgusting and foul part of caring for their pet. Conventional methods of disposal include using a shovel or a plastic bag. The shovel is usually large and awkward to manipulate and cannot usually be taken on walks with the pet. Alternatively, the plastic bag is easily transportable so it may be placed in a pocket for use during outdoor activities. The down side of the plastic bags is that the owner must use their hand to pick up the waste, thereby feeling the warmth of the feces and its softness. Also, most of the plastic bags are not biodegradable therefore creating excessive waste for the environment.

Some alternative animal disposal products have been developed, for example U.S. Pat. No. 3,286,826 by S. E. Stoll discloses a dog refuse package wherein a bag includes a separate scoop to scoop the feces and then drop both the scoop and feces into the bag for disposal. This method is easy to use but it still utilizes a bag which the user must grasp for use. Alternatively, U.S. Pat. No. 4,830,419 by Eric R. Wantanabe discloses a disposable animal waste collector wherein the waste collector includes a scooping portion along the bottom to lift the animal waste and then a covering that slides from an upper portion to enclose the waste. The disposable animal waste collector also includes a handle to prevent the user from touching the enclosed portion. A problem with the disposable animal waste collector is that it utilizes two separate pieces for use making it non-functional if one of the pieces is missing.

It would be beneficial in the art to provide a receptacle to easily dispose of animal waste that is a singular unit to scoop and dispose of the waste. It would also be desirable in the art to provide a receptacle that is biodegradable to be environmentally friendly.

### SUMMARY OF THE INVENTION

An object of the present invention is to provide a waste disposal scoop that comprises a scooping portion attached to a conical body portion to both scoop and accept animal waste in a single receptacle.

Another object of the present invention is to provide a waste disposal scoop made from a material that is both recyclable and biodegradable.

Another object of the present invention is to provide a waste disposal scoop that includes an adhesive strip to secure the enclosed animal waste within the waste disposal scoop.

In view of the foregoing disadvantages inherent in the prior art, the purpose of the present disclosure is to provide a waste disposal scoop comprising a conical body, where the conical body extends between a base at a lower portion to a folded edge at an upper portion, a front flap attached to the folded edge, where the front flap folds to rest against the conical body, a back scoop attached to an opposing portion of the conical body from the folded edge, where the back scoop lifts an amount of animal waste to accept the animal waste into the conical body, and an adhesive strip attached to an end of the front flap, wherein the adhesive strip secures the front flap to the back scoop after the amount of animal waste is within the conical body.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a waste disposal scoop in accordance with an exemplary embodiment of the present invention;

FIG. 2A depicts a perspective view of a waste disposal scoop in an open position in accordance with an exemplary embodiment of the present invention;

FIG. 2B depicts a perspective view of a waste disposal scoop in a closed position in accordance with an exemplary embodiment of the present invention; and

FIG. 2C depicts a perspective view of a waste disposal scoop in a folded position in accordance with an exemplary embodiment of the present invention.

Like reference numerals refer to like parts throughout the description of several views of the drawings.

### DETAILED DESCRIPTION OF THE DRAWINGS

The present invention relates to a waste disposal scoop to enable a user to dispose of pet waste by providing a disposable container including an adhesive strip to scoop, seal and dispose of the waste. The waste disposal scoop comprises a generally conical shape so that the pet waste may be easily accepted and held within the receptacle. After use, the top portion of the waste disposal scoop is sealed with an adhesive strip to better contain the animal waste. The unique design of the waste disposal scoop decreases the smells, tactile sensations and diminishes heat transfer through the scoop when the user grabs the cone. The materials used for the waste disposal scoop are recyclable and biodegradable for responsible disposal, and are strong enough to be used in most outdoor environments including grass, concrete and sand. Overall, the waste disposal scoop makes collecting and disposing of pet waste easy and more environmentally responsible.

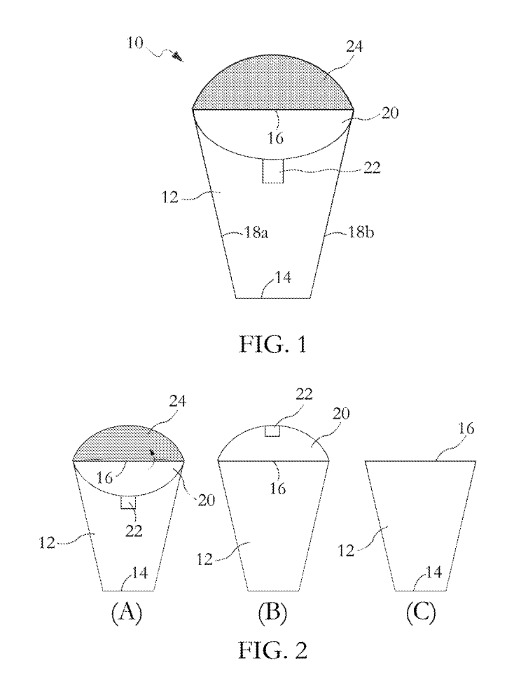

Turning now descriptively to the drawings, referring to FIG. 1, a perspective view of a waste disposal scoop (10) is shown in accordance with an exemplary embodiment of the present invention. The waste disposal scoop (10) may include a conical body (12) that stretches between a base (14) up to a folded edge (16). The conical body (12) may be formed from a single piece of heavyweight paper, lightweight cardboard or biodegradable plastic by wrapping diagonal corners around each other to create a cone wherein a top portion is wider than a bottom portion. The conical body (12) is hollow to accept feces, litter and similar animal waste products.

The base (14) may be formed after folding a bottom portion of the conical body (12) and pressing it against the conical body (12). The base (14) creates a bottom or a closure to keep the animal waste from sliding through the bottom portion of the waste disposal scoop (10). At an upper portion of the conical body (12) is the folded edge (16). The folded edge (16) creates a partition for a front flap (20). The front flap (20) hangs from the folded edge (16) and rests against the conical body (12).

Attached to an end of the front flap (20) may be an adhesive strip (22). The adhesive strip (22) may secure the front flap (20) to an opposing portion of the conical body (12). The opposing portion of the conical body (12) may be a back scoop (24). The back scoop (24) may be used to pick up or scrape the animal waste into the conical body (12). On each side of the conical body (12) may be a pair of side edges (18a, 18b). The pair of side edges (18a, 18b) may provide a gripping area for a user to place their hands. While grasping the side edges (18a, 18b) the user may adjust how wide the conical body (12) opens to accept the animal waste.

Referring now to FIG. 2A, a perspective view of the waste disposal scoop (10) is shown in an open position in accordance with an exemplary embodiment of the present invention. When the front flap (20) is folded in front of the conical body (12) along the folded edge (16), the waste disposal scoop (10) is in the open position. Accordingly, referring to FIG. 2B, a perspective view of the waste disposal scoop (10) is shown in a closed position in accordance with an exemplary embodiment of the present invention. While in the closed position, the front flap (20) is secured against the back scoop (24). The adhesive strip (22) secures the front flap (20) to the back scoop (24) to ensure that the inner animal waste remains secure within the conical body (12).

Alternatively, referring to FIG. 2C, a perspective view of the waste disposal scoop (10) is shown in a folded position in accordance with an exemplary embodiment of the present invention. Rather than simply securing the front flap (22) against the back scoop (24) as in the closed position an alternative disposal position may be configured into the folded position, wherein the back scoop (24) folds to meet the folded edge (16) and the front flap (20) folds above it. While in the folded position the waste disposal scoop (10) has a more compact structure than when in the closed position, thus it is more compact for disposal.

For storage purposes, the waste disposal scoop (10) may be pressed flat to create a stack by placing them one on top of the other. This enables multiple waste disposal scoops (10) to be stored together in a compact fashion. The user may then remove the individual waste disposal scoops (10) from the stack when needed for use.

To use the waste disposal scoop (10), first the user may press the side edges (18a, 18b) together so that the conical body (12) is in the open position. Second, the user may scoop the animal waste onto the back scoop (24) by sliding it beneath the animal waste. Third, the user may lift the back scoop (24) and allow the animal waste to slide into the conical body (12), coming to rest at the base (14). After the animal waste is inside the conical body (12), the user may fold the front flap (20) back against the back scoop (24), and secure the two together with the adhesive strip (24) to be disposed of in the closed position. Alternatively, the back scoop (24) may fold towards the folded edge (16), and the front flap (20) may be pressed and secured above the back scoop (24) to be disposed of in the folded position. Once sealed the waste disposal scoop (10) may be disposed of in a trash receptacle.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A waste disposal scoop comprising:
a conical body, where said conical body extends between a base at a lower portion to a folded edge at an upper portion;
a front flap attached to said folded edge, where said front flap folds to rest against said conical body;
a back scoop attached to an opposing portion of said conical body from said folded edge, where said back scoop lifts an amount of animal waste to accept said animal waste into said conical body; and
an adhesive strip attached to an end of said front flap, wherein said adhesive strip secures said front flap to said back scoop after said amount of animal waste is within said conical body.

2. The waste disposal scoop according to claim 1, wherein said folded edge and said back scoop move between an open position, a closed position and a folded position.

3. The waste disposal scoop according to claim 2, wherein said open position includes said front flap resting against said conical body while said back scoop remains extended to scoop said amount of animal waste.

4. The waste disposal scoop according to claim 2, wherein said closed position includes said front flap secured against said back scoop secured with said adhesive strip to enclose said amount of animal waste within said conical body.

5. The waste disposal scoop according to claim 2, wherein said folded position includes said back scoop folded towards said folded edge and said front flap is secures above said back scoop with said adhesive strip to enclose said amount of animal waste within said conical body.

6. The waste disposal scoop according to claim 1, wherein said conical body is made from a recyclable and biodegradable material.

7. The waste disposal scoop according to claim 1, wherein said conical body includes a pair of side edges to enable a user to squeeze said pair of side edges to open said conical body.

8. The waste disposal scoop according to claim 1, wherein said conical body is pressed into a flat position to enable a plurality of conical bodies to be stacked.

9. A method of use for a waste disposal scoop comprising the steps of:
pressing side edges on each side of a conical body to enable said conical body to open;
scooping an amount of animal waste onto a back scoop attached to said conical body by sliding said back scoop beneath said amount of animal waste;
lifting said back scoop to slide said amount of animal waste into said conical body;
folding a front flap of said conical body back against said back scoop; and
securing said front flap to said back scoop using an adhesive strip attached to said front flap.

10. The method of use for the waste disposal scoop according to claim 9, further comprising the steps of folding said back scoop towards said front flap and folding said front flap back over said back scoop.

11. The method of use for the waste disposal scoop according to claim 9, further comprising the step of disposing of said waste disposal scoop into a trash receptacle.
